(19) United States
(12) Patent Application Publication
(10) Pub. No.: US 2005/0131617 A1
(43) Pub. Date: Jun. 16, 2005

(54) Data collecting system and data transmitting method

(75) Inventors: Hideaki Nii, Tokyo (JP); Ichiro Kawabuchi, Tokyo (JP)

Correspondence Address: YOUNG & THOMPSON, 745 SOUTH 23RD STREET, 2ND FLOOR, ARLINGTON, VA, 22202, US

(73) Assignees: PIONEER CORPORATION, TOKYO (JP); TECHEXPERTS INCORPORATON, TOKYO (JP)

(21) Appl. No.: 10/985,967

(22) Filed: Nov. 12, 2004

(30) Foreign Application Priority Data
Nov. 13, 2003 (JP) 2003-384013

(51) Int. Cl. G06G 7/70

(52) U.S. Cl. 701/100

(57) ABSTRACT

A data collecting system includes a data collecting device and plural data processing devices connected to the data collecting device by a cascade connection. For example, each of the data processing devices individually executes an A/D conversion and other data process, and adds data obtained by the data process to a data transmitting signal to transmit it to the subsequent cascade-connection data processing device in sequence. The data processing device at the head of the cascade connection generates the data transmitting signal including a data processing period and a communication period, and transmits it to the subsequent data processing device. Each of the data processing devices executes the data process in the data processing period, and transmits data obtained by the data process to the subsequent data processing device in the communication period on the basis of the data transmitting signal.

### BACKGROUND OF THE INVENTION

1. Field of the Invention

The present invention relates to a data collecting system for collecting data which are outputted from plural data processing devices.

2. Description of Related Art

When data detected by plural sensors are transmitted to a data analyzing device so as to be analyzed, generally, a data collecting system is configured by connecting plural data outputting devices for outputting the data detected from the sensors and the data analyzing device to a common bus. In that case, the data analyzing device serves as a host, and individually obtains the data from each data outputting device by designating each data outputting device on the basis of addresses and the like. Therefore, the plural data outputting devices transmit the data by an interrupting process under control of the data analyzing device so that the data analyzing device obtains the data from the plural data outputting devices in real time.

Therefore, it is required that the respective data outputting devices extract the data detected from the sensors and transmit the detected data by the interrupting process. For example, when an analog sensor is used as the sensor, since the data outputting device has to A/D-convert an analog detecting signal, which is outputted from the sensor, and transmit it, process loads required to the respective data outputting devices become large. In addition, when one data outputting device A/D-converts analog detected data from the sensor during the transmission of the data from another data outputting device to the data analyzing device, it can happen that accuracy of A/D conversion is problematically reduced by a noise caused by the transmission of the data by another data outputting device.

There is a method of transmitting data by so-called cascade connection or daisy chain connection, not by the above-mentioned connection of the plural data outputting devices to the common bus. This method is disclosed in Japanese Patent Application Laid-open under No. 2001-145093 and No. 2001-251609.

### SUMMARY OF THE INVENTION

The present invention has been achieved in order to solve the above problems. It is an object of this invention to provide a data collecting system, whose configuration is simple, capable of effectively collecting plural data without an effect of a noise due to communication.

According to one aspect of the present invention, there is provided a data collecting system which includes a data collecting device and plural data processing devices connected to the data collecting device by a cascade connection, each of the data processing devices sharing repeated data processing period and communication period with each other, individually executing a data process in the data processing period, and adding data obtained by the data process in the communication period to a data transmitting signal received from the preceding data processing device, to transmit it to the subsequent data processing device.

Each of the data processing devices individually executes an A/D conversion and other data process, for example, and adds the data obtained by the data process to the data transmitting signal to transmit it to the subsequent cascade-connection data processing device in sequence. More concretely, the data processing device at the head of the cascade connection periodically transmits starting information of the data transmitting period and starting information of a data processing period in order to prescribe the data processing period and the communication period of the whole data collecting system.

At that time, the data transmitting signal includes the data processing period and the communication period. In the data processing period, all the data processing devices execute the data process, and never transmit the data to the subsequent data processing devices. Thereby, it can be prevented that a noise caused by the transmission of the data puts an adverse effect on the data process in all the data processing devices. On the other hand, in the communication period, the respective data processing devices transmit the data obtained by the data process in sequence. Therefore, the respective data processing devices can execute the data process without the effect of the noise, and can efficiently transmit a result thereof to the data collecting device.

If the data processing period in the data transmitting signal is set to be longer than a maximum data processing time by the plural data processing devices, all the data processing devices can start transmitting the data in the communication period after individually completing the data process.

In addition, the communication period in the data transmitting signal may include an individual communication period assigned to each of the plural data processing devices. Since each of the data processing devices transmits the data in the individual communication period assigned to its data processing device, the data collecting device can correctly discriminate the data which are transmitted from the plural data processing devices. By continuously assigning the individual communication period within the communication period, the communication period can be used efficiently.

In a preferred embodiment, each of the data processing devices may include an A/D converter which executes A/D conversion as the data process. More concretely, each of the data processing devices may be connected to an analog sensor, and may A/D-convert an analog detecting signal which is outputted from the analog sensor as the data process. Since the data is not transmitted during the A/D converting process in each of the data processing devices, it can be prevent that accuracy of A/D conversion is decreased due to a noise caused by the data transmission.

In addition, it is preferable that the data processing device at the head of the cascade connection periodically transmits the data transmitting signal with a cycle longer than a total of the data processing period and the communication period. Thereby, the data collecting system can periodically obtain accurate data from each of the data processing devices.

According to another aspect of the present invention, there is provided a data transmitting method which is executed among plural cascade-connection data processing devices, the data processing device at a head of the cascade connection generating a data transmitting signal including a data processing period and a communication period, and transmitting it to the subsequent data processing device, and each of the data processing devices executing a data process in the data processing period, and transmitting data obtained by the data process to the subsequent data processing device in the communication period based on the data transmitting signal. By the data transmitting method, identically to the above-mentioned data collecting system, a data process can accurately be executed in each of the data processing devices, and the data can effectively be transmitted to other devices.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a block diagram schematically showing a configuration of a robot arm controlling system to which a data collecting system according to an embodiment of the present invention is applied.

FIGS. 2A and 2B are block diagrams showing an inside configuration of a data processing device shown in FIG. 1.

FIGS. 3A to 3E are timing charts showing data transmitting signals among data processing devices.

### DETAILED DESCRIPTION OF THE PREFERRED EMBODIMENTS

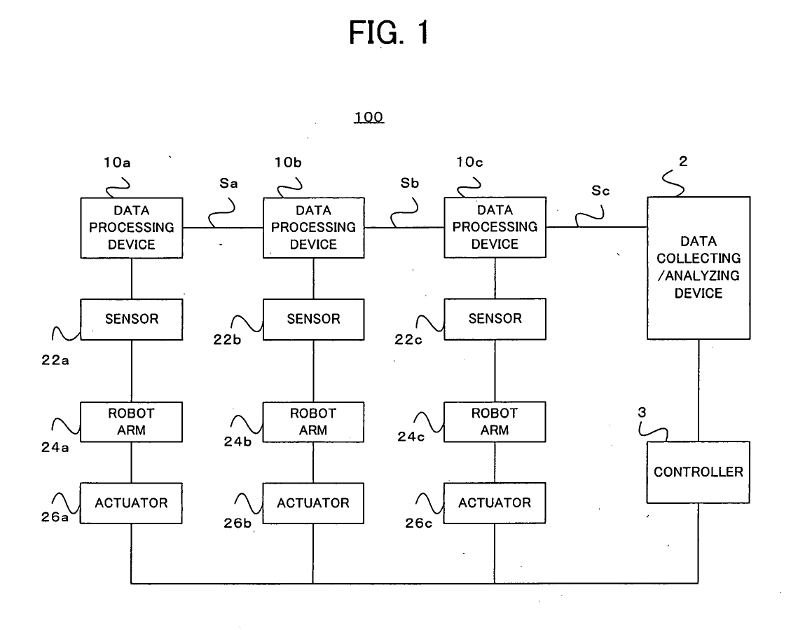

The preferred embodiments of the present invention will now be described below with reference to the attached drawings. FIG. 1 schematically shows a configuration of a robot arm controlling system to which a data collecting system according to an embodiment of the present invention is applied.

In FIG. 1, a robot arm controlling system 100 controls positions of plural robot arms, and controls three robot arms 24a to 24c in the present embodiment. Namely, as shown in FIG. 1, the robot arm controlling system 100 includes data processing devices 10a to 10c, sensors 22a to 22c, the robot arms 24a to 24c, actuators 26a to 26c, a data collecting/analyzing device 2 and a controller 3.

The positions of the respective robot arms 24a to 24c are controlled by the actuators 26a to 26c which use air pressure, for example. The respective actuators 26a to 26c are controlled by the controller 3.

The positions of the robot arms 24a to 24c are detected by the sensors 22a to 22c, respectively. In the present embodiment, the respective sensors 22a to 22c are configured as analog sensors for detecting the positions of the robot arms 24a to 24c, and output analog detecting signals indicating the detected positions of the robot arms 24a to 24c to the respective data processing devices 10a to 10c.

The data processing devices 10a to 10c A/D-convert the analog detecting signals indicating the positions of the robot arms 24a to 24c which are supplied from the sensors 22a to 22c, and output them as digital detecting signals.

The data processing devices 10a to 10c are connected to the data collecting/analyzing device 2 by a serial connection system which is generally called “cascade connection” or “daisy chain”. Namely, the data processing device 10a which is located at the head of the cascade connection supplies a data transmitting signal Sa to the subsequent data processing device 10b, and the data processing device 10b supplies a data transmitting signal Sb to the further subsequent data processing device 10c. The data processing device 10c supplies a data transmitting signal Sc to the data collecting/analyzing device 2.

The data processing devices 10a to 10c add digital detecting signals Da to Dc corresponding to the sensors 22a to 22c to the data transmitting signals Sa to Sc respectively, and transmit them to the subsequent data processing apparatus 10 or the data collecting/analyzing device 2, though the detail will be explained later. In such the method, the digital detecting signals Da to Dc corresponding to the sensors 22a to 22c are collected and analyzed by the data collecting/analyzing device 2. In the present embodiment, the data collecting/analyzing device 2 analyzes the positions of the respective sensors 22a to 22c on the basis of the collected digital detecting signals Da to Dc, and outputs, to the controller 3, position controlling quantities of the respective robot arms 24a to 24c in accordance with the result. The controller 3 drives the respective actuators 26a to 26c on the basis of the position controlling quantities of the respective sensors 22a to 22c which are obtained from the data collecting/analyzing apparatus 2, and controls the positions of the respective robot arms 24a to 24c. In the present embodiment, the positions of the robot arms 24a to 24c are feedback-controlled in such the method. Such the position control, by detecting the digital detecting signals Da to Dc and collecting the data to analyze it, is repeatedly and periodically executed.

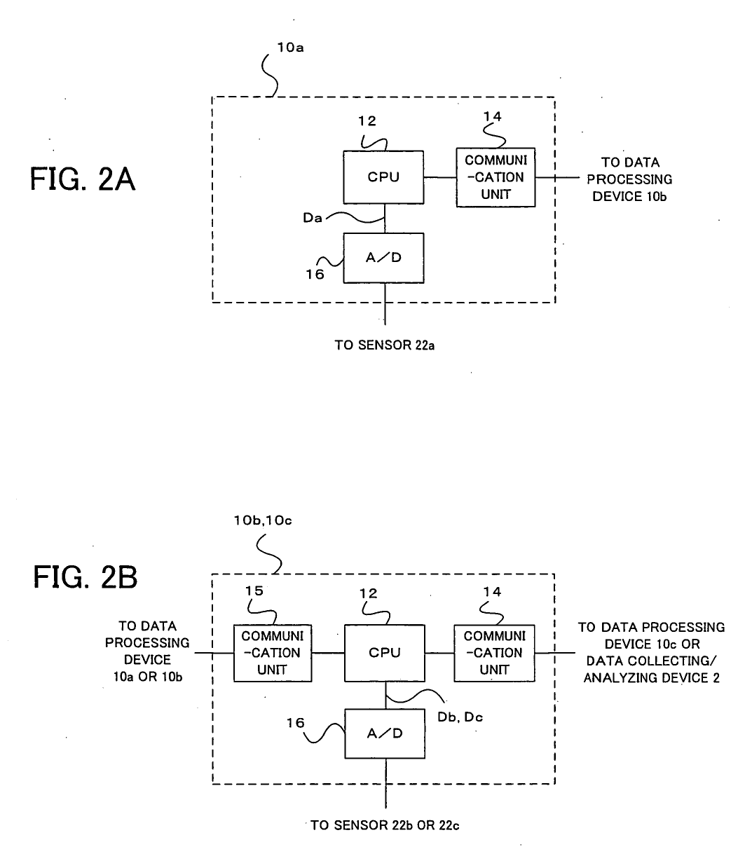

Next, the description will be given of inside configurations of the data processing devices 10a to 10c. FIG. 2A shows the inside configuration of the data processing apparatus 10a located at the head of the cascade connection, and FIG. 2B shows the inside configuration of the data processing devices 10b and 10c located at positions subsequent to the data processing apparatus 10a.

As shown in FIG. 2A, the data processing device 10a includes an A/D converter 16, a communication unit 14 and a CPU 12 for control. The A/D converter 16 A/D-converts the analog detecting signal which is supplied from the sensor 22a, and generates the digital detecting signal Da. The CPU 12 generates data transmitting signals for transmitting the digital detecting signals Da to Dc through the cascade-connection data processing devices 10a to 10c, and adds the digital detecting signal Da to the data transmitting signal as the need arises. The communication unit 14 transmits the data transmitting signal to the subsequent data processing device 10b under the control of the CPU 12.

On the other hand, as shown in FIG. 2B, each of the subsequent data processing devices 10b and 10c includes the CPU 12, the communication unit 14, a communication unit 15 and the A/D converter 16. Namely, each of the data processing devices 10b and 10c includes the communication unit 15 for performing communication with the data processing device 10a or 10b located at the upstream position of the cascade connection in addition to the configuration of the data processing device 10a.

Identically to the data processing device 10a, the A/D converter 16 A/D-converts the analog detecting signal which is supplied from the correspondent sensor 22b or 22c, and generates the digital detecting signal Db or Dc. The communication unit 15 receives the data transmitting signal Sa or Sb from the preceding data processing device 10a or 10b. The CPU 12 adds, to the data transmitting signal Sa or Sb, the digital detecting signal Db or Dc generated by the A/D converter 16, and supplies it to the communication unit 14. The communication unit 14 outputs the data transmitting signal Sb or Sc. It is noted that the data processing device 10b supplies the data transmitting signal Sb to the subsequent data processing device 10c, and the data processing device 10c supplies the data transmitting signal Sc to the data collecting/analyzing device 2.

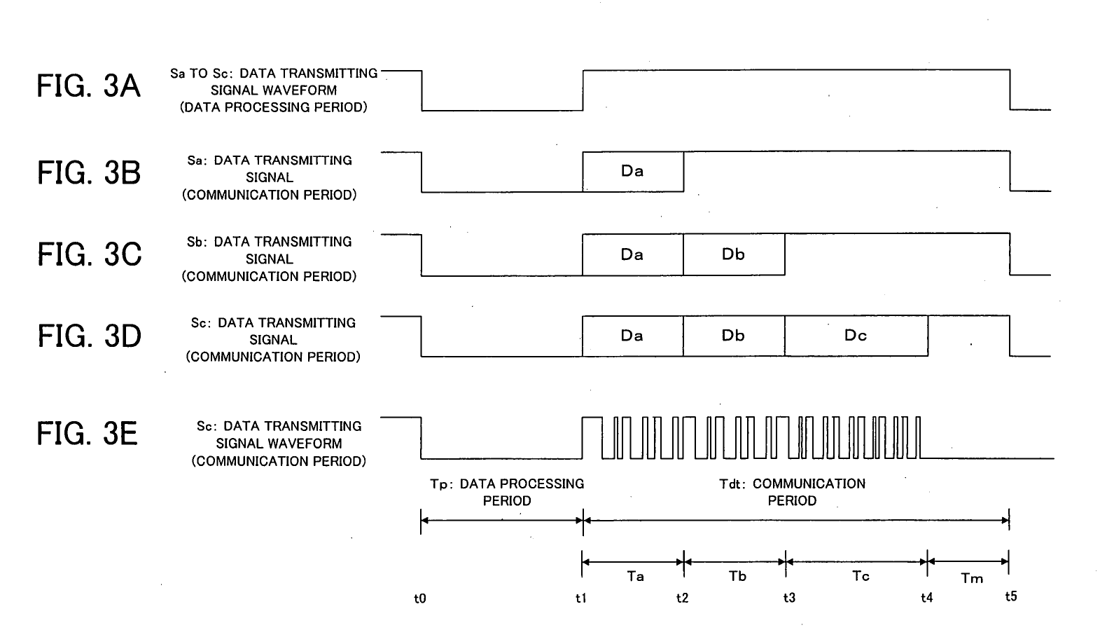

Next, the description will be given of details of a method of transmitting the data among the plural cascade-connection data processing devices 10a to 10c, with reference to FIGS. 3A to 3E. FIGS. 3A to 3E are timing charts showing the data transmitting signals which are communicated among the data processing devices 10a to 10c. In FIGS. 3A to 3E, the data transmitting signals outputted from the data processing devices 10a, 10b and 10c are indicated as Sa, Sb and Sc, respectively, identically to those shown in FIG. 1.

In the present embodiment, the data processing device 10a located at the head of the cascade connection generates the data transmitting signal. The present invention is characterized in that the data transmitting signal includes a data processing period Tp and a communication period Tdt, as shown in FIGS. 3A to 3E. In the data processing period Tp, the respective data processing devices 10a to 10c execute the data process, and do not communicate (transmit) the data. Namely, the data processing period Tp is set as a period in which the respective data processing devices execute only the data process. In the present embodiment, the data process is an A/D converting process of the analog detecting signal by the A/D converter 16. Like this, the data processing devices 10a to 10c share the data processing period Tp and the communication period Tdt, and the data processing period Tp and the communication period Tdt are periodically and repeatedly executed.

FIG. 3A shows a waveform of data transmitting signal outputted from the respective data processing devices 10a to 10c in the data processing period Tp. Since outputting the data from the respective data processing devices 10a to 10c is inhibited in the data processing period Tp, output data is not included at the position corresponding to the communication period Tdt.

Like this, by providing the data processing period Td dedicated to only the data processing, in which the respective data processing devices 10a to 10c do not transmit the data and only individually execute the data process, in the data transmitting signals S, it can be prevented that a noise which may occur due to the data communication affects the data process in the respective data processing devices. For example, as for the A/D conversion in the present embodiment, if a certain data processing device executes the data communication during the A/D converting process of anther data processing device, the effect of the noise caused by the data communication is given to the A/D converting process, and accuracy of the A/D conversion sometimes decreases. Like the present embodiment, when a subject of the A/D converting process as the data process is the analog detecting signal of the sensor 22, a detected quantity may change by the effect of the noise due to the communication, and an adverse effect is given to the control of the whole system. In this point, as described above, if the data processing period Tp is provided and all the data processing devices never execute the communication in the period, the data process can be executed in the respective data processing devices with high accuracy.

Therefore, the data processing period Tp is set to be longer than the longest necessary time of the data processes executed in the plural data processing devices 10a to 10c. Thereby, it can be prevented that the data communication is started before all the data processing devices individually complete the data process.

On the other hand, the communication period Tdt is set as a period in which the respective data processing devices 10a to 10c transmit the data in sequence. The communication period Tdt includes individual communication periods Ta to Tc, which are assigned to the respective data processing devices 10a to 10c, and a margin period Tm. Though the communication period Tdt is dedicated to the data transmission, if the respective data processing devices 10a to 10c transmit the data in disorder, the data collecting/analyzing device 2 cannot identify from which data processing device the received data is transmitted. Therefore, the individual communication periods Ta to Tc are set in the communication period Tdt. Namely, it is prescribed that the data processing devices 10a to 10c transmit the data during the individual communication periods Ta to Tc, respectively. Thereby, the data collecting/analyzing device 2 can regard the data transmitted□@in each individual communication period as the data which is transmitted from the data processing device 10 corresponding to the individual communication period.

FIGS. 3B to 3D schematically show data contents of the data transmitting signals Sa to Sc which are outputted from the respective data processing devices 10a to 10c in the communication period Tdt. The data transmitting signal Sa outputted from the data processing device 10a includes the digital detecting signal Da, and the digital detecting signal Db is added to the data transmitting signal Sb outputted from the data processing device 10b. The digital detecting signal Dc is further added to the data transmitting signal Sc outputted from the data processing device 10c. In addition, FIG. 3E shows an example of a waveform of the data transmitting signal Sc shown in FIG. 3D.

The lengths (time widths) of the respective individual communication periods Ta to Tc are determined in accordance with the quantities of the data which are outputted from the respective data processing devices. Namely, a long individual communication period is given to the data processing device having a large output data quantity, and a short individual communication period is given to the data processing device having a small output data quantity. When data transmitting speed is constant, the length (time width) of the individual communication period is prescribed by the quantity of the data to be transmitted.

As a method of setting the individual communication period, first the time width (transmission data quantity) of the correspondent individual communication period device may be determined on the basis of the output data quantity from each data processing, and may be set in the communication period Tdt in sequence. For example, if it is assumed that the output data quantities from the data processing devices 10a and 10b are 12 bits respectively and the output data quantity from the data processing device 10c is 16 bits, a period from starting time t1 of the communication period Tdt to a period corresponding to the data quantity 12 bits, i.e., time t2, may be set to the individual communication period Ta, and a period from starting time t2 to a period corresponding to the data quantity 12 bits, i.e., time t3, may be set to the individual communication period Tb. Moreover, a period from time t3 to a period corresponding to the data quantity 16 bits, i.e., time t4, may be set to the individual communication period Tc. Like this, by setting each individual communication period, each of the data processing devices 10a to 10c adds its output data (each of the digital detecting signals Da to Dc) within the correspondent individual communication period in the communication period Tdt of the data transmitting signal S in sequence, and transmits the data to the data processing device at the downstream position. Finally, the output data from all the data processing devices is transmitted to the data collecting/analyzing device 2 through the cascade connection. The margin period Tm is set for the purpose of a stable execution of a data transmitting process.

It is preferable that the plural individual communication periods are continuously set on a time axis (i.e., without an interval). More concretely, for example, in examples of FIGS. 3A to 3E, each individual communication period is set so that the next individual communication period Tb starts immediately after the end of the individual communication period Ta. Thereby, efficient communication becomes possible.

It is noted that the data processing device 10a located at the head of the cascade connection periodically generates the data transmitting signal with a cycle longer than the total of the data processing period Tp and the communication period Tdt, and transmits it. Namely, in order to prescribe the data processing period Tp and the communication period Tdt of the whole robot arm controlling system 100, the data processing device 10a periodically transmits the starting information of the data processing period Tp and also the starting information of the data communication period Tdt. Timing of transmitting the starting information is designed on the basis of an individual timer included in the data processing device 10a.

In the examples of FIGS. 3A to 3E, in the communication period Tdt of the data transmitting signal, the individual communication period is arranged in sequence from the data processing device 10a at the upstream position of the cascade connection to the data processing device 10c at the downstream position. However, the arrangement is not indispensable. Namely, in the communication period Tdt, if the plural individual communication period is set in an order not to be overlapped with each other on the time axis, the sequence is not necessarily from the data processing device at the upstream position of the cascade connection to the data processing device at the downstream position.

In the above embodiment, the description was given of the example that the data collecting system of the present invention was applied to the robot arm control system. However, the application of the present invention is not limited to the robot arm control system. Namely, the present invention can be applied to various systems and circumstances for supplying the output data from the plural data processing devices and data outputting devices to the predetermined devices by the cascade connection.

In addition, in the above embodiment, the A/D converting process of the analog output signal from the sensor is illustrated as the example of the data process which is executed in each of the data processing devices. However, the application of the present invention is not limited to that case, and the present invention can be applied to the data processing device which executes various data processes. In the present invention, since the data processing period is set and transmission of the data is inhibited during the period, it is particularly effective to apply the present invention to a data processing device which executes a data process comparatively sensitive to a noise.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2003-384013 filed on Nov. 13, 2003 including the specification, claims, drawings and summary is incorporated herein by reference in its entirety.

1. A data collecting system comprising:
a data collecting device; and
plural data processing devices connected to the data collecting device by a cascade connection,
each of the data processing devices sharing repeated data processing period and communication period with each other, individually executing a data process in the data processing period, and adding data obtained by the data process in the communication period to a data transmitting signal received from the preceding data processing device, to transmit it to the subsequent data processing device.

2. The data collecting system according to claim 1, wherein the data processing device at a head of the cascade connection periodically transmits starting information of the data transmitting period and starting information of the data processing period in order to define the data processing period and the communication period of the whole data collecting system.

3. The data collecting system according to claim 1, wherein the data processing period is longer than a maximum data processing time in each of the data processing devices.

4. The data collecting system according to claim 1, wherein the communication period comprises individual communication period which is assigned to each of the plural data processing devices.

5. The data collecting system according to claim 4, wherein the individual communication period is continuously assigned in the communication period.

6. The data collecting system according to claim 1, wherein each of the data processing devices comprises an A/D converter which executes A/D conversion as the data process.

7. The data collecting system according to claim 6, wherein each of the data processing devices is connected to an analog sensor, and A/D-converts an analog detecting signal which is outputted from the analog sensor as the data process.

8. The data collecting system according to claim 1, wherein the data processing device at the head of the cascade connection periodically transmits the data transmitting signal with a cycle longer than a total of the data processing period and the communication period.

9. A data transmitting method which is executed among plural cascade-connection data processing devices,
the data processing device at a head of the cascade connection generating a data transmitting signal including a data processing period and a communication period, and transmitting it to the subsequent data processing device, and
each of the data processing devices executing a data process in the data processing period, and transmitting data obtained by the data process to the subsequent data processing device in the communication period based on the data transmitting signal.
